(19) United States
(12) Patent Application Publication
(10) Pub. No.: US 2026/0008660 A1
(43) Pub. Date: Jan. 8, 2026

(54) OBSTACLE PROTECTION STRUCTURE OF LIFTING COLUMN

(71) Applicant: TIMOTION TECHNOLOGY CO., LTD., New Taipei City (TW)

(72) Inventor: Yu-Chang LIN, New Taipei City (TW)

(21) Appl. No.: 19/201,495

(22) Filed: May 7, 2025

Related U.S. Application Data
(60) Provisional application No. 63/668,143, filed on Jul. 5, 2024.

(51) Int. Cl. B66F 17/00; B66F 3/44

(52) U.S. Cl. CPC B66F 17/00; B66F 3/44

(57) ABSTRACT

This disclosure is a lifting column. A box body (10) has a chamber (13). A driving mechanism (20) is disposed in the chamber (13) and includes a motor (21) and a reduction gear set (22). A transmission mechanism (30) includes a movement (31), which is connected to and driven by the reduction gear set (22). A protection structure (40) includes a support member (41), a force sensor (45), and an elastic member (47). The support member (41) is fixed to the box body (10) and is configured to abut against the periphery of the motor (21), the elastic member (47) is disposed on the support member (41), and the force sensor (45) is disposed on the elastic member (47).

### CROSS-REFERENCE TO RELATED APPLICATION

This patent application claims the benefit of U.S. Provisional Patent Application No. 63/668,143, filed Jul. 5, 2024, which is incorporated by reference herein.

### BACKGROUND OF THE DISCLOSURE

### Technical Field

The technical field relates to a lifting column, and particularly to an obstacle protection structure of a lifting column.

### Description of Related Art

A lifting column is commonly used in electric beds, nursing beds, hospital beds, and electric height-adjustable tables or chairs to adjust height or tilt angles. When the lifting column encounters an obstacle during the adjustment process, it may come into contact with the obstacle, generating a reaction force that is transmitted to the linear actuator. If the lifting column does not stop operating immediately, it may be damaged by the obstacle. Moreover, if the obstacle is part of the human body, injury may occur.

In order to address the above issue, the industry has implemented protection mechanisms on the lifting columns to detect obstacles. Currently, high-sensitivity obstacle protection mechanisms use obstacle detection components to convert pressure signals into electrical signals. However, when the deformation at the installation location of the obstacle detection component is relatively small, the resulting stress may be insufficient to trigger an obstacle alert. In some cases, sufficient stress to activate the obstacle detection component is generated only after a certain period following a collision between the lifting column and the obstacle. Moreover, the response speed of existing obstacle protection mechanisms is too slow and therefore fails to meet the practical requirements of current applications.

In view of the above drawbacks, the inventor proposes this disclosure based on his expert knowledge and elaborate researches in order to solve the problems of related art.

### SUMMARY OF THE DISCLOSURE

This disclosure provides an obstacle protection structure of a lifting column, in which the lifting column may interrupt its movement upon encountering an obstacle, thereby reducing the risk of collision damage to objects and enhancing safety during use.

This disclosure is an obstacle protection structure includes a box body, a driving mechanism, a transmission mechanism, and a protection structure. The box body has a chamber. The driving mechanism is disposed in the chamber and includes a motor and a reduction gear set, which is connected to and driven by the motor. The transmission mechanism includes a movement, which is connected to and driven by the reduction gear set. The protection structure includes a support member, a force sensor, and an elastic member. The support member is fixed to the box body and is configured to abut against the periphery of the motor, the elastic member is disposed on the support member, and the force sensor is disposed on the elastic member. When the reduction gear set, which drives the movement, is obstructed, the motor rotates about the movement as a center axis to deform the elastic member, and the force sensor detects a deformation of the elastic member.

This disclosure provides the following advantages: the lifting column may accurately detect changes caused by external forces and offers higher protection precision and sensitivity when encountering obstacles. Additionally, the shape of the strain gauge is not limited, and the installation locations of the strain gauges are more flexible.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 depicts an assembly schematic view of the first embodiment of this disclosure.

FIG. 2 depicts a perspective exploded schematic view of the first embodiment of this disclosure.

FIG. 3 depicts a cross-sectional schematic view of the first embodiment of this disclosure.

FIG. 4 depicts a cross-sectional schematic view of another side of the first embodiment of this disclosure.

FIG. 5 depicts an assembly schematic view of the second embodiment of this disclosure.

FIG. 6 depicts a perspective exploded schematic view of the second embodiment of this disclosure.

FIG. 7 depicts a cross-sectional schematic view of the second embodiment of this disclosure.

FIG. 8 depicts a cross-sectional schematic view of another side of the second embodiment of this disclosure.

FIG. 9 depicts an assembly schematic view of the third embodiment of this disclosure.

FIG. 10 depicts a perspective exploded schematic view of the third embodiment of this disclosure.

FIG. 11 depicts a cross-sectional schematic view of the third embodiment of this disclosure.

FIG. 12 depicts a cross-sectional schematic view of another side of the third embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

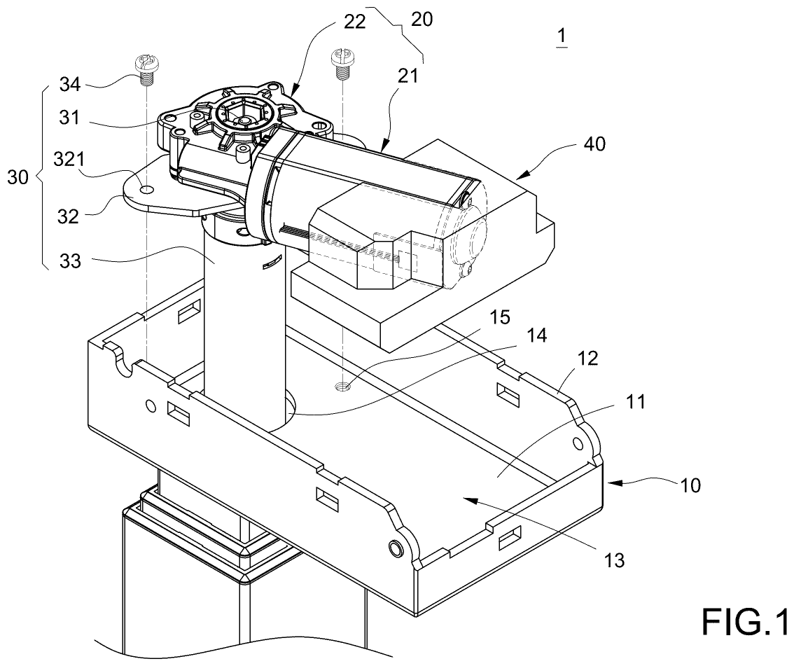

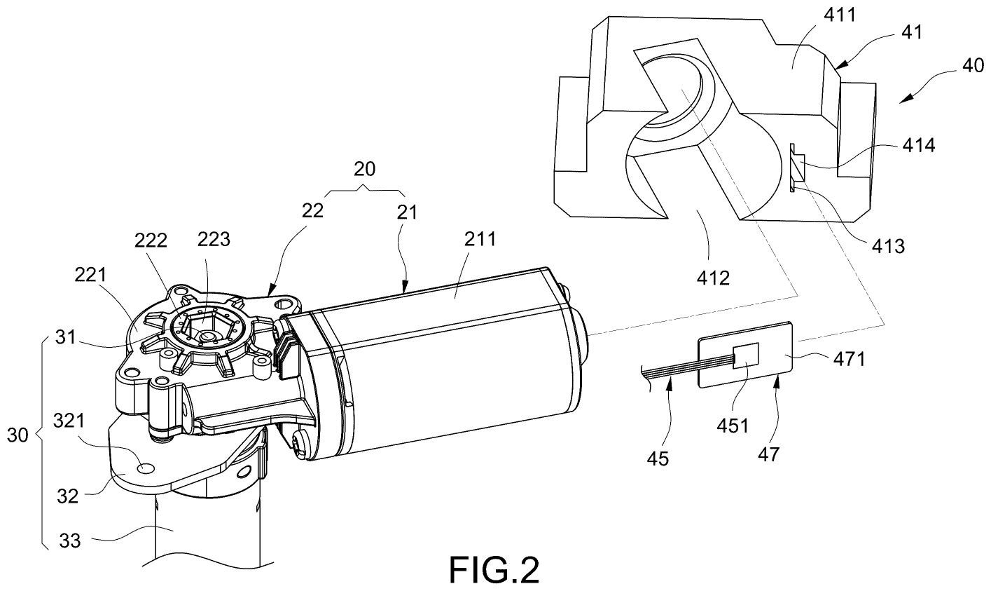

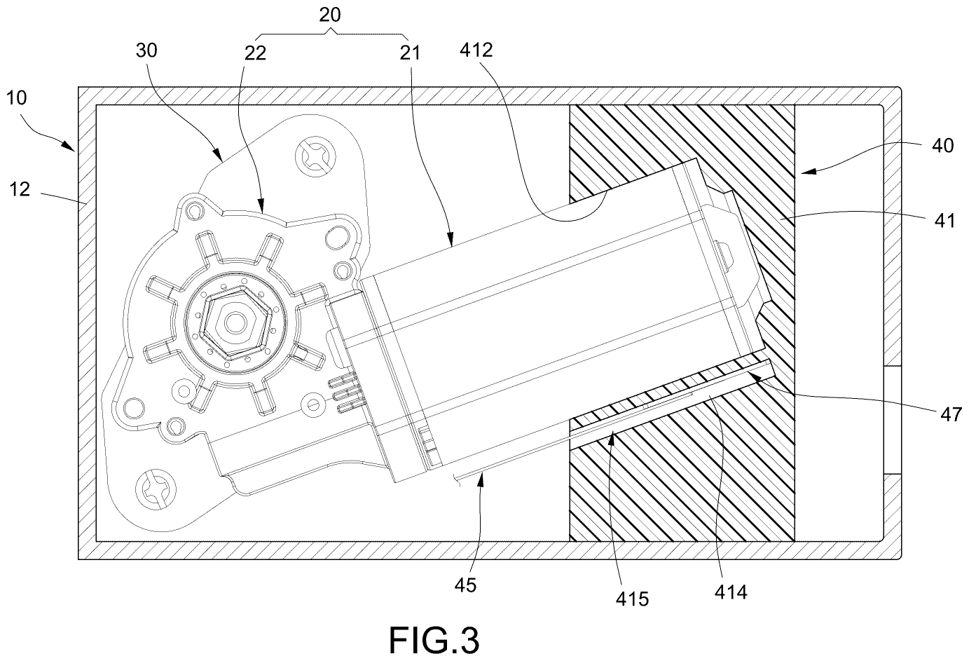

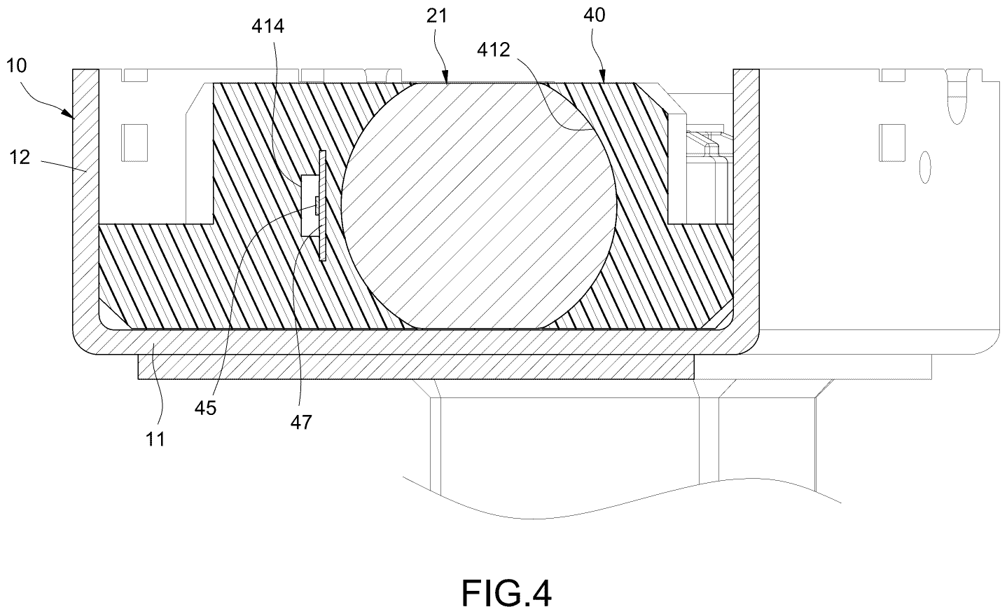

With reference to FIGS. 1 to 4, this disclosure provides an obstacle protection structure of a lifting column 1. The lifting column 1 mainly includes a box body 10, a driving mechanism 20, a transmission mechanism 30, and a protection structure 40.

The box body 10 is substantially rectangular in shape and mainly includes a bottom plate 11 and a plurality of side plates 12 connected to the bottom plate 11. A chamber 13 is defined by the bottom plate 11 and the side plates 12. Additionally, a through hole 14 and a plurality of screw holes 15 are defined on the bottom plate 11.

The driving mechanism 20 is arranged in the chamber 13 of the box body 10 and mainly comprises a motor 21 and a reduction gear set 22. The motor 21 is configured to generate both forward rotation and reverse rotation. It mainly includes a casing 211 and the associated components (not shown in figures), such as a rotor-stator assembly, accommodated in the casing 211. The reduction gear set 22 is connected to one end of the motor 21 and mainly includes a housing 221 and a gear set (not shown in figures) arranged inside the housing 221. The gear set may include an assembly of a worm and a worm gear, or a combination of multiple spur gears, and is driven by the motor 21 to produce rotational motion. A rotating member 222 is positioned at the center of the housing 221, and a socket hole 223 is defined on the center of the rotating member 222. In this embodiment, the socket hole 223 is a regular hexagon in shape, but this is not limited thereto. The rotating member 222 is connected to and driven by the gear set, allowing it to rotate relative to the housing 221.

The transmission mechanism 30 includes a movement 31, a fixing seat 32, a telescopic tube 33, a plurality of screw elements 34, and other associated elements. One end of the movement 31 passes through the through hole 14 and is accommodated in the socket hole 223, while the other end of the movement 31 extends into the telescopic tube 33. Two perforations 321 and a central hole (not shown in figures) are defined in the fixing seat 32. The central hole is configured to receive the movement 31, and each perforation 321 is inserted by a screw element 34, which is fastened to a corresponding screw hole 15 in the bottom plate 11. The driving mechanism 20 is connected to the movement 31 solely via the socket hole 223 of the reduction gear set 22, and the side of the driving mechanism 20 on the motor 21 is neither fixed nor secured. This arrangement allows the driving mechanism 20 to rotate about the movement 31 as a center axis, causing the tail section of the casing 211 to rotate (or oscillate) in the horizontal direction.

The protection structure 40 of this disclosure is disposed at the tail section of the casing 211 of the motor 21. The protection structure 40 primarily includes a support member 41, a force sensor 45, and an elastic member 47. In this embodiment, the support member 41 mainly includes a stepped block 411, which may be a deformable member made of rubber or similar materials. A receiving groove 412 is defined in the center of the block 411 to accommodate the casing 211 of the motor 21. A first slot 413 and a second slot 414, which communicates with the first slot 413, are defined on the side of the receiving groove 412 of the block 411. The height of the first slot 413 is greater than that of the second slot 414. The block 411 is disposed in the chamber 13 of the box body 10 and is clamped and secured by two side plates 12 opposite to each other of the box body 10. The force sensor 45 is disposed on the elastic member 47, which is embedded in the first slot 413. The elastic member 47 is positioned adjacent to the casing 211 of the motor 21. The force sensor 45 is located in the second slot 414, and a gap 415 is defined between the force sensor 45 and the wall of the second slot 414.

In this embodiment, the force sensor 45 is a resistance strain gauge 451, which is electrically connected to a control device (not shown in figures). When a force is applied to the elastic member 47, the force sensor 45 is deformed, resulting in a change in resistance. This change in resistance is processed by the control device and output as an electrical signal. In this embodiment, the elastic component 47 is a sheet-shaped rubber pad 471.

When the lifting column 1 encounters an obstacle during the ascending or descending process, the rotation of the movement 31, driven by the reduction gear set 22, may be obstructed. As a result, the current of the motor 21 increases, and the motor 21 rotates about the movement 31 as a center axis. The torque required for the lifting column 1 to operate increases, and the pressure exerted by the reduction gear set 22 on the support member 41 also increases. This pressure is transmitted through the support member 41 to the elastic member 47. The elastic member 47 deforms in response to the change in pressure, and the force sensor 45 deforms together with the elastic member 47. The force sensor 45 then generates a corresponding signal and outputs the change in the amount of deformation.

In this embodiment, the force sensor 45 is disposed between the two side plates 12 of the box body 10 and the casing 211 of the motor 21. When the lifting column 1 encounters an obstacle, the motor 21 detects changes in force or displacement at the tail section of the casing 211 due to the reaction torque resulting from a change in the applied torque. This enables the lifting column 1 to achieve a protective effect when encountering obstacles. Minor variations in the torque of the motor 21 may be detected immediately by the force sensor 45. When an obstacle is encountered, the torque of the motor 21 is the first parameter to change. The detection point of the protection structure 40 acts directly on the casing 211 of the motor 21, thereby effectively reducing the response time of the lifting column 1 and enhancing detection sensitivity.

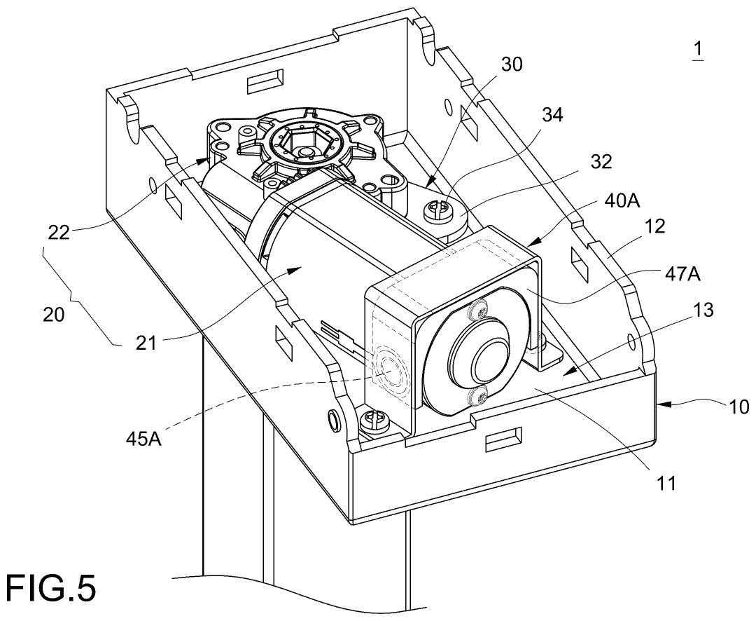

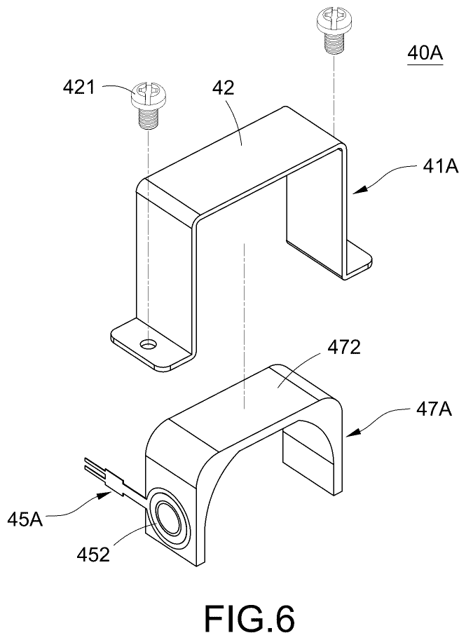

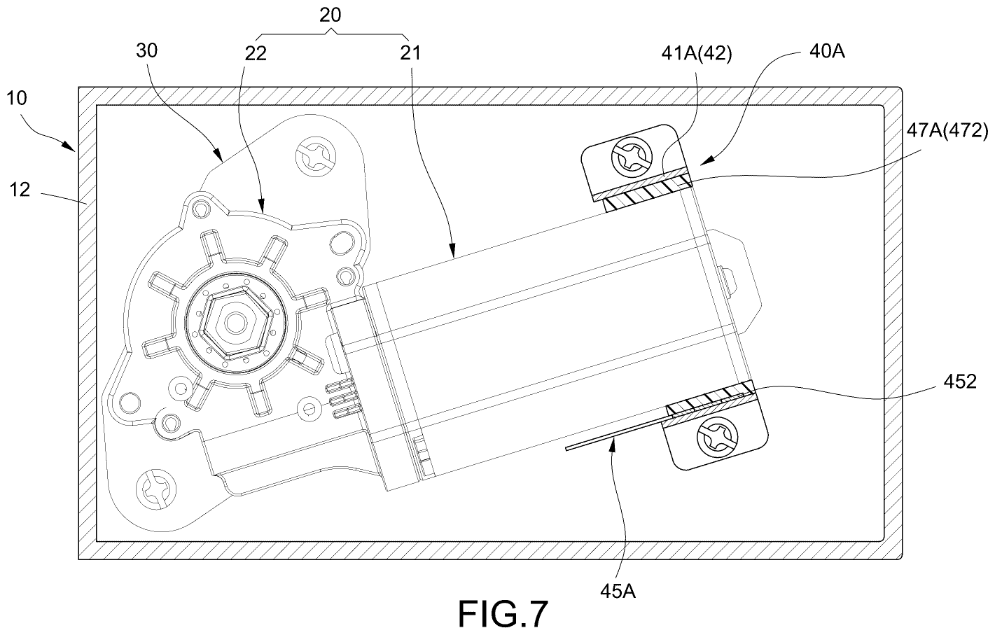

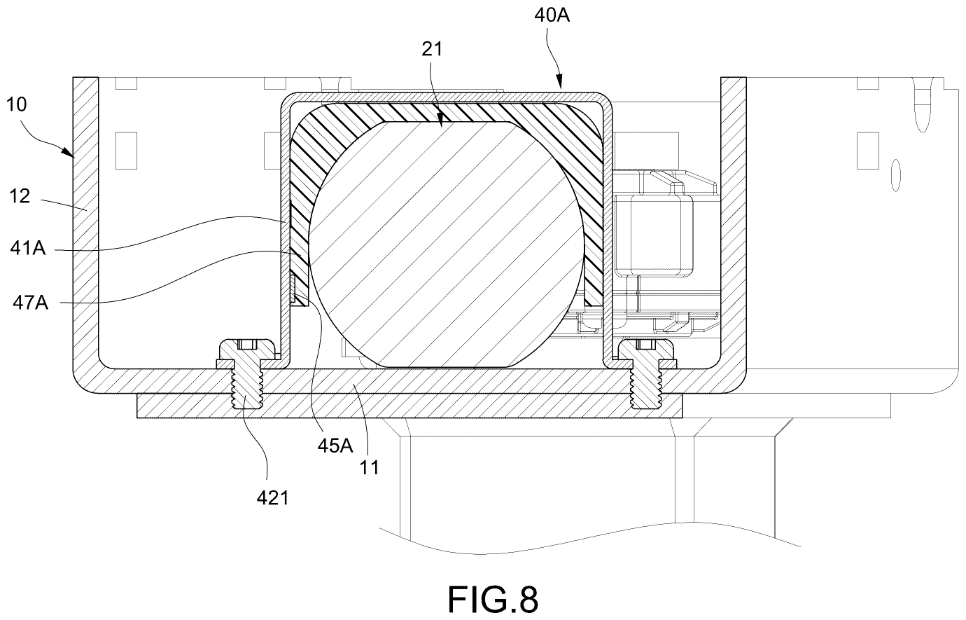

With reference to FIGS. 5 to 8, the protection structure of the lifting column in this disclosure may be as described in the previous embodiment or as in the present embodiment. In this embodiment, the protection structure 40A mainly includes a support member 41A, a force sensor 45A, and an elastic member 47A. The support member 41A includes a U-shaped frame 42 and a plurality of screws 421. The two sides of the opening of the U-shaped frame 42 are respectively fixed to the screw holes 15 of the bottom plate 11 by screws 421. In this embodiment, the force sensor 45A is a piezoelectric sensor 452, and the elastic member 47A is a U-shaped rubber pad 472. The U-shaped rubber pad 472 is mounted on the rear section of the casing 211 of the motor 21 and is located inside the U-shaped frame 42. The piezoelectric sensor 452 is positioned between the U-shaped frame 42 and the U-shaped rubber pad 472, adjacent to the arc edge of the casing 211.

When the lifting column 1 encounters an obstacle during the ascending or descending process, the rotation of the movement 31, driven by the reduction gear set 22, may be obstructed. As a result, the current supplied to the motor 21 increases, and the motor 21 rotates about the movement 31 as a center axis. The torque required for the lifting column 1 to operate increases, and the pressure exerted by the reduction gear set 22 on the U-shaped rubber pad 472 also increases. The pressure is transmitted through the U-shaped rubber pad 472 to the piezoelectric sensor 452. The piezoelectric sensor 452 deforms in response to the pressure, and the resulting deformation generates a corresponding signal, which is then output.

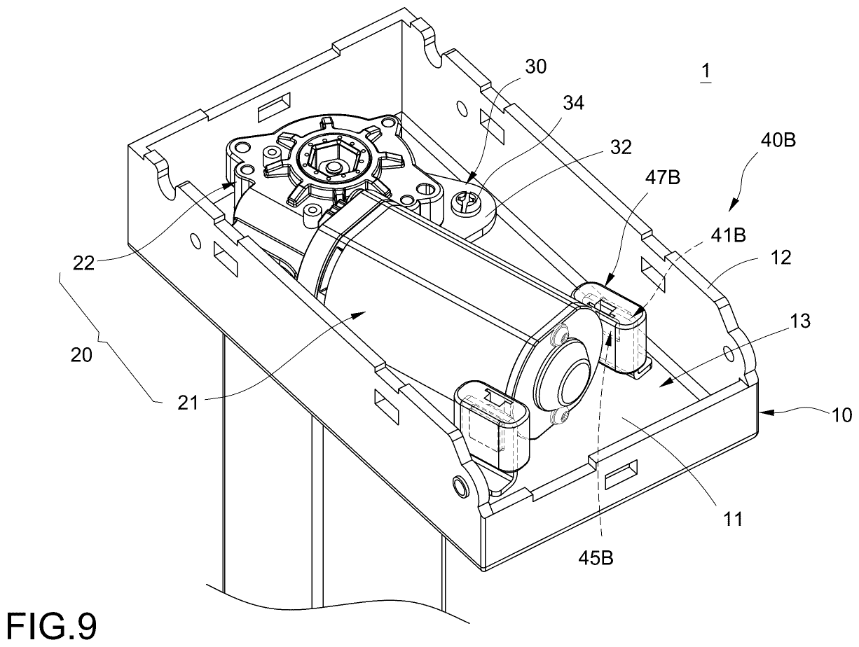

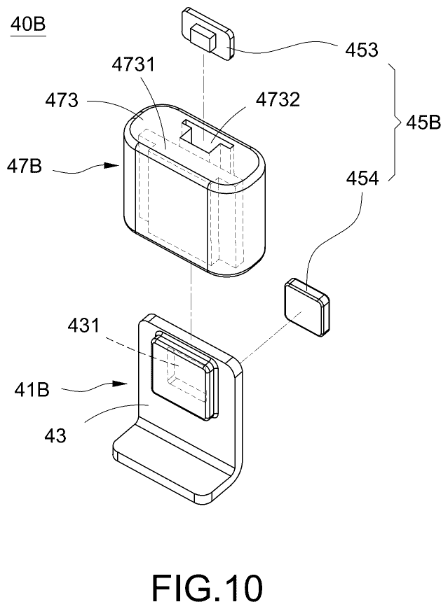

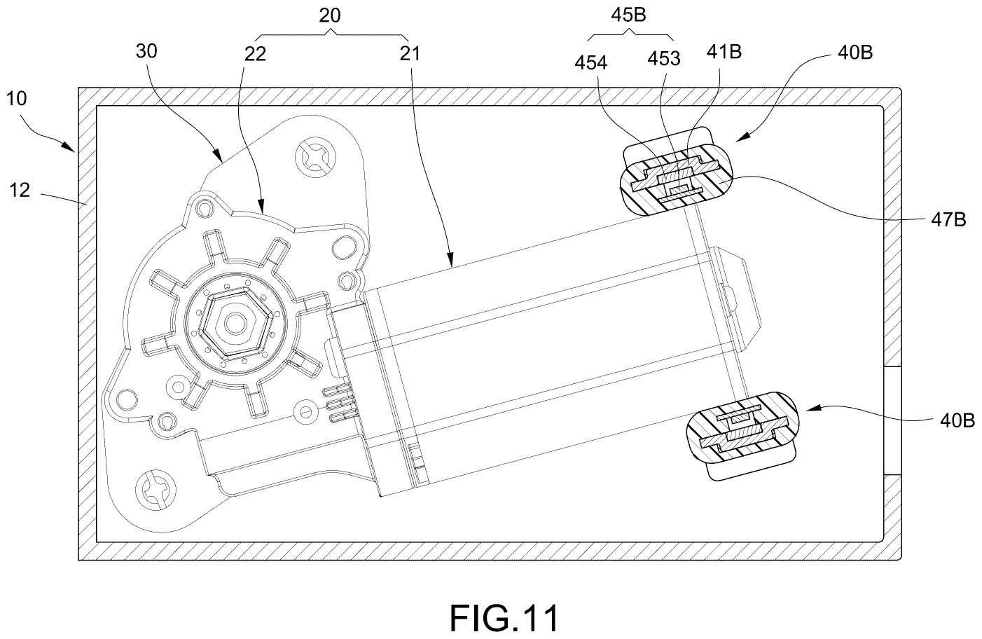

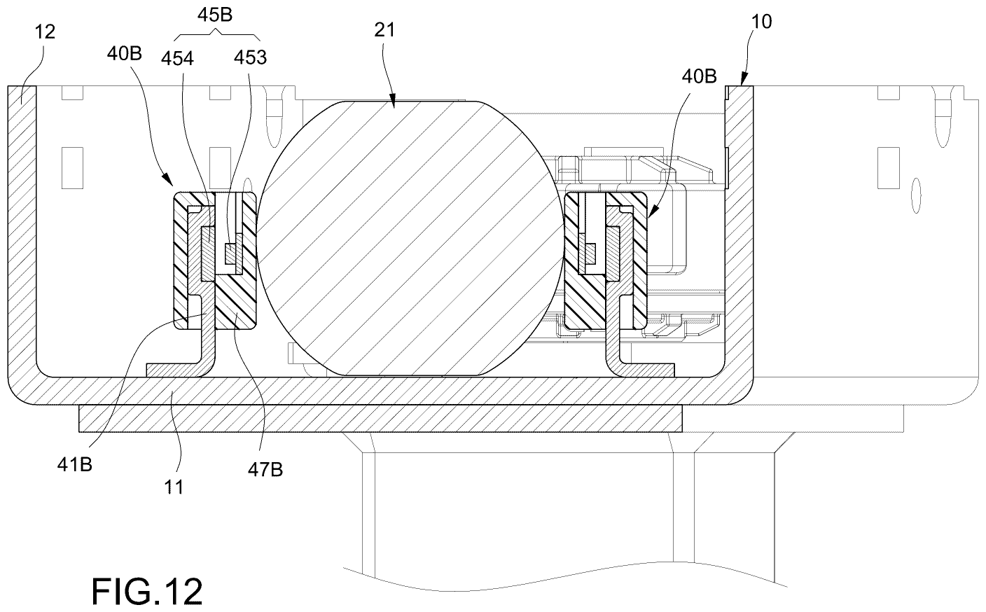

With reference to FIGS. 9 to 12, the protection structure of the lifting column in this embodiment is substantially the same as those in the first and second embodiments, and the difference is that the number of protection structures 40B is two. Each protection structure 40B mainly includes a support member 41B, a force sensor 45B, and an elastic member 47B. The support member 41B of this embodiment is an L-shaped plate 43. One end of the L-shaped plate 43 is welded to the bottom plate 11 and is located at the tail section of the casing 211 of the motor 21. A notch 431 is defined at the other end of the L-shaped plate 43. The force sensor 45B in this embodiment mainly includes a Hall element (Hall sensor) 453 and a magnetic body 454. The elastic member 47B in this embodiment is a block-shaped rubber pad 473. A blind groove 4731 and an embedding groove 4732 are defined on the elastic member 47B. The Hall element 453 is positioned in the embedding groove 4732, and the magnetic body 454 is accommodated in the notch 431. The block-shaped rubber pad 473 is mounted on the L-shaped plate 43 via the blind groove 4731, such that the Hall element 453 is arranged corresponding to the magnetic body 454. Additionally, the magnetic body 454 may be a magnet or a magnetized element.

When the lifting column 1 encounters an obstacle during the ascending or descending process, the rotation of the movement 31, driven by the reduction gear set 22, may be obstructed. As a result, the current supplied to the motor 21 increases, and the motor 21 rotates about the movement 31 as a center axis. The torque required for the lifting column 1 to operate increases, and the pressure exerted by the reduction gear set 22 on the L-shaped plate 43 also increases. This pressure is transmitted through the block-shaped rubber pad 473 to the Hall element 453. The Hall element 453 generates a corresponding signal by detecting changes in magnetic field strength or magnetic polarity between the Hall element 453 and the magnetic body 454, and subsequently outputs the signal.

Furthermore, as mentioned in the above example, the number of the protection structure 40B may be two. However, for certain specifications of the lifting column 1, the protection structure 40B may be implemented as a single unit. Additionally, the protection structure 40B may be disposed at the tail section of the casing 211 of the motor 21 (not shown in figures).

While this disclosure has been described by means of specific embodiments, numerous modifications and variations may be made thereto by those skilled in the art without departing from the scope and spirit of this disclosure set forth in the claims.

What is claimed is:

1. A lifting column, comprising:
a box body (10), comprising a chamber (13); and
a driving mechanism (20), disposed in the chamber (13), comprising a motor (21) and a reduction gear set (22) connected to and driven by the motor (21);
a transmission mechanism (30), comprising a movement (31) connected to and driven by the reduction gear set (22); and
a protection structure (40), comprising a support member (41), a force sensor (45), and an elastic member (47), wherein the support member (41) is fixed to the box body (10) and configured to abut against a periphery of the motor (21), the elastic member (47) is disposed on the support member (41), and the force sensor (45) is disposed on the elastic member (47);
wherein, when the reduction gear set (22), which is driving the movement (31), is obstructed, the motor (21) rotates about the movement (31) as a center axis to deform the elastic member (47), and the force sensor (45) detects a deformation of the elastic member (47).

2. The lifting column according to claim 1, wherein the protection structure (40) is disposed at an end of the motor (21) away from the reduction gear set (22).

3. The lifting column according to claim 1, wherein the reduction gear set (22) comprises a housing (221); a rotating member (222) is disposed on the housing (221), and a socket hole (223) connected with the movement (31) is defined on the rotating member (222).

4. The lifting column according to claim 1, wherein the support member (41) comprises a block (411); the box body (10) comprises two side plates (12) opposite to each other, and the block (411) is clamped and fixed between the two side plates (12); a receiving groove (412) is defined in the block (411), and the motor (21) is disposed in the receiving groove (412).

5. The lifting column according to claim 4, wherein a first slot (413) and a second slot (414) communicating with the first slot (413) are defined on one side of the receiving slot (412) of the block (411), the elastic member (47) is embedded in the first slot (413), and the force sensor (45) is disposed in the second slot (414).

6. The lifting column according to claim 5, wherein the elastic member (47) is a sheet-shaped rubber pad (471), and the force sensor (45) is a resistance strain gauge (451).

7. The lifting column according to claim 1, wherein the support member (41A) comprises a U-shaped frame (42), the U-shaped frame (42) covers the motor (21) and is fixed to the box body (10), the elastic member (47A) is clamped between the U-shaped frame (42) and the motor (21), and the force sensor (45A) is positioned between the U-shaped frame (42) and the elastic member (47A).

8. The lifting column according to claim 7, wherein the elastic member (47A) is a U-shaped rubber pad (472) disposed inside the U-shaped frame (42).

9. The lifting column according to claim 7, wherein the force sensor (45A) is a piezoelectric sensor (452).

10. The lifting column according to claim 1, wherein the support member (41B) comprises an L-shaped plate (43); one end of the L-shaped plate (43) is fixed to the box body (10), and a notch (431) is defined on another end of the L-shaped plate (43); the force sensor (45B) comprises a Hall element (453) and a magnetic body (454), and an embedding groove (4732) is defined on the elastic member (47B); the Hall element (453) is positioned in the embedding groove (4732), and the magnetic body (454) is accommodated in the notch (431).

11. The lifting column according to claim 10, wherein the elastic member (47B) is a block-shaped rubber pad (473); a blind groove (4731) is defined on the elastic member (47B); the elastic member (47B) is mounted on the L-shaped plate (43) via the blind groove (4731), and the Hall element (453) is arranged corresponding to the magnetic body (454).

12. The lifting column according to claim 1, wherein a number of the support member (41B), a number of the force sensor (45B) and a number of the elastic member (47B) are multiple.
